(19) United States
(12) Patent Application Publication
(10) Pub. No.: US 2003/0136863 A1
(43) Pub. Date: Jul. 24, 2003

(54) Process and apparatus for slushing contaminated recovered paper

(75) Inventor: Lothar Pfalzer, Ravensburg (DE)

Correspondence Address: GREENBLUM & BERNSTEIN, P.L.C., 1950 ROLAND CLARKE PLACE, RESTON, VA, 20191, US

(73) Assignee: Voith Paper Patent GmbH, Heidenheim (DE)

(21) Appl. No.: 10/347,345

(22) Filed: Jan. 21, 2003

(30) Foreign Application Priority Data
Jan. 24, 2002 (DE) 102 02 629.7

(51) Int. Cl. B02C 17/00; B02C 17/10

(52) U.S. Cl. 241/24.29; 241/28; 241/183

(57) ABSTRACT

Process and apparatus for slushing contaminated recovered paper in a slushing device including a rotatable drum having first and second face on axial ends and at least one displacement body having an outside wall curved at least in sections located inside drum and held from outside of the drum to form processing channel between at least curved section of outside wall of displacement body and at least a part of an inside wall of drum to mechanically process the recovered paper. Process includes feeding recovered paper with impurities into drum on first face, moving recovered paper and impurities within drum from first to second face, and transporting recovered paper and impurities out of drum at second face together via a rotating coil. The instant abstract is neither intended to define the invention disclosed in this specification nor intended to limit the scope of the invention in any way.

### CROSS-REFERENCE TO RELATED APPLICATIONS

The present application claims priority under 35 U.S.C. § 119 of German Patent Application No. 102 02 629.7, filed on Jan. 24, 2002, the disclosure of which is expressly incorporated by reference herein in its entirety.

### BACKGROUND OF THE INVENTION

1. Field of the Invention

The invention relates to a process for slushing contaminated recovered paper, which is fed into a horizontal drum on its first face and is moved within the drum from the first to the second face. The inside wall of the drum is moved at at least 20 cm/sec in the circumferential direction and at least one displacement body having an outside wall curved at least in sections is located inside the drum is held from the outside. The displacement body forms a processing channel with at least the curved part of its outside wall and at least one part of the inside wall of the drum. In the processing channel, a mechanical processing of the recovered paper takes place.

2. Discussion of Background Information

Such a process is known, e.g., from German Application No. DE 197 36 143 A1. Here contaminated recovered paper is to be mixed with water and crushed, which is easily possible with the processing channel described there. A dissolving drum is thereby described, the faces of which are essentially closed by non-rotating disks sealed against the drum. The supply and removal of the pulp is then accomplished through openings made in these disks.

Even though the known dissolving process already produces very good results, problems can occur under particularly unfavorable conditions during discharge of the pulp from this dissolving drum. This applies in particular when the recovered paper to be slushed is very heavily contaminated with larger contaminant parts. For instance, plastic foils, bailing wires and other long, flexible strips that occur in large quantities can be problematic.

### SUMMARY OF THE INVENTION

The present invention therefore develops the known process so that the discharge of the stock from the dissolving drum can be improved and can be made safer to operate.

In particular, the present invention is directed to a process in which the recovered paper treated in the drum is transported out at the second face together with the contained impurities with the aid of a rotating coil.

The coil installed in the discharge area of the drum first has the effect that the pulp can be discharged from the drum in a defined manner according to the conveyance effect of such coils, which effect is known per se. A bottom slurry forms in the lower area which is dammed up there at the most up to the upper edge of the coil. The pulp gathered between the coils is conveyed axially outwards by the rotation of the drum. The transported amount then depends on the rotational speed of the drum. If this is a disadvantage, the coil can also have a separate abrasion and, e.g., rotate more slowly than the drum.

An important effect of the measures according to the invention is that the inside edge of the coil surface has a conveyance effect directed upwards in the area in that the drum wall is moved upwards. It is now planned to use this conveyance effect primarily for the movement of the large and coarse contaminants. This conveyance effect can be advantageously intensified by projecting teeth, edges or hooks. Collections of contaminants or correspondingly large impurities can thus no longer remain in the bottom area of the drum, and by adhering there continue to spin following contaminants. Instead they are transported upwards in time, e.g., over the displacement body and dropped down again on the opposite side. This can lead first of all to a pulling apart of accumulations of such pulps, which can already be regarded as favorable. As an additional measure, special discharge devices can be available in the fall area for the falling contaminants. However, it is also possible that these devices are not necessary if an adequate axial transport occurs due to the general movement in the drum. It is to be expected that the falling refuse is also taken along for a distance by the fibrous material mass transported in the axial direction. By repeatedly moving these contaminants upward and downward, they are reliably discharged from the drum. Naturally, tilting the drum can also lead to an axial transport—albeit only a slight one—occurring by the contaminants merely falling.

The present invention is directed to a process for slushing contaminated recovered paper in a slushing device that includes a rotatable drum having a first and second face on opposite axial ends and at least one displacement body having an outside wall curved at least in sections located inside the drum and held from outside of the drum, such that a processing channel is formed between at least the curved section of the outside wall of the displacement body and at least a part of an inside wall of the drum in order to mechanically process the recovered paper. The process includes feeding recovered paper contaminated with impurities into the drum on the first face, moving the recovered paper and impurities within the drum from the first to the second face, and transporting the recovered paper and impurities out of the drum at the second face together with the aid of a rotating coil.

According to a feature of the invention, the process can further include rotating the inside wall of the drum at at least 20 cm/sec in the circumferential direction.

In accordance with another feature of the present invention, backwash for the recovered paper to be treated in the drum may be formed with the coil.

Moreover, the impurities can include long impurities and an inside of the coil may include at least one of projections and edges. Further, the process can include transporting at least a part of the long impurities over the displacement body via the at least one of projections and edges, and subsequently releasing the at least a part of the long impurities from the at least one of the projections and edges.

According to still another feature of the present invention, the process can include rotating the drum and the coil at a same rotational speed. Alternatively, the process can include rotating the drum and the coil at different rotational speeds. In this regard, the coil can be moved at a lower rotational speed than the drum.

In accordance with a further aspect of the invention, the coil may be arranged with a height of at least 30 cm radially inwardly from the inside wall of the drum.

According to another aspect of the instant invention, the drum may be oriented horizontally. Alternatively, the drum can be oriented such that, during operation, a longitudinal axis of the drum is oriented at an angle of tilt to a horizontal reference of between 0.5 and 10°, and, preferably, the longitudinal axis can be oriented at an angle of between about 0.5 to 2°.

Further, the drum can include transporting bars attached to the inside wall that are arranged to lift the pulp inside the drum.

The process may also include detaching impurities adhering to the coil by spraying the coil with at least one pressure water jet directed axially. The at least one pressure water jet may be formed by a jet tube attached to an upper part of the displacement body.

According to further features of the invention, the drum can have an interior diameter of at least 2 m. Moreover, the drum may have a length of at least 6 m.

In accordance with the invention, the drum may not be perforated. Alternatively, the drum can be perforated on a maximum of 30% of its axial length directly in front of the second face.

In accordance with another feature, an axial length of the coil is at least 10% of an axial length of the drum.

According to still another feature of the invention, an axial length of the coil can be at least 2 m.

Further, at least a part of the processing channel can be located within an axial area of the coil.

The present invention is directed to an apparatus for slushing contaminated recovered paper. The apparatus includes a rotatable drum having a first and second face on opposite axial ends, such that the first face is structured and arranged to receive recovered paper contaminated with impurities, and at least one displacement body having an outside wall curved at least in sections. The at least one displacement body is located inside the drum and arranged to form a processing channel between at least the curved section of the outside wall of the displacement body and at least a part of an inside wall of the drum in order to mechanically process the recovered paper, and the at least one displacement body is held within the drum from outside of the drum. A rotatable coil is positioned at the second face of the drum and arranged to transport the recovered paper and impurities out of the drum at the second face.

In accordance with a feature of the invention, the inside wall of the drum can be rotatable in the circumferential direction at at least 20 cm/sec.

Further, the coil may be structured and arranged to form backwash for the recovered paper to be treated in the drum.

Moreover, an inside of the coil includes at least one of projections and edges structured and arranged to transport at least a part of long impurities over the displacement body via the at least one of projections and edges, and subsequently releasing the at least a part of the long impurities from the at least one of the projections and edges.

In accordance with another feature of the invention, the drum and the coil are rotatable at a same rotational speed. Alternatively, the drum and the coil may be rotatable at different rotational speeds. In this regard, the coil can be rotated at a lower rotational speed than the drum.

According to another feature of the present invention, the coil may be structured with a height of at least 30 cm radially inwardly from the inside wall of the drum.

Further, the drum can be oriented horizontally, or, alternatively, the drum may be oriented such that, during operation, a longitudinal axis of the drum is oriented at an angle of tilt to a horizontal reference of between 0.5 and 10°, and, preferably, the longitudinal axis is oriented at an angle of between about 0.5 to 2°.

In accordance with the invention, the drum can include transporting bars attached to the inside wall that are structured and arranged to lift the recovered paper inside the drum.

In accordance with still yet another feature of the present invention, the apparatus may also include at least one pressure water jet axially directed to detach impurities adhering to the coil. The at least one pressure water jet can include a jet tube attached to an upper part of the displacement body.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a sectional side view of a drum suitable for the process of the instant invention;

FIG. 2 illustrates a face view of the drum depicted in FIG. 1;

FIG. 3 illustrates a horizontal orientation of the drum in accordance with the invention; and

FIG. 4 illustrates a tilted orientation of the drum in accordance with the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

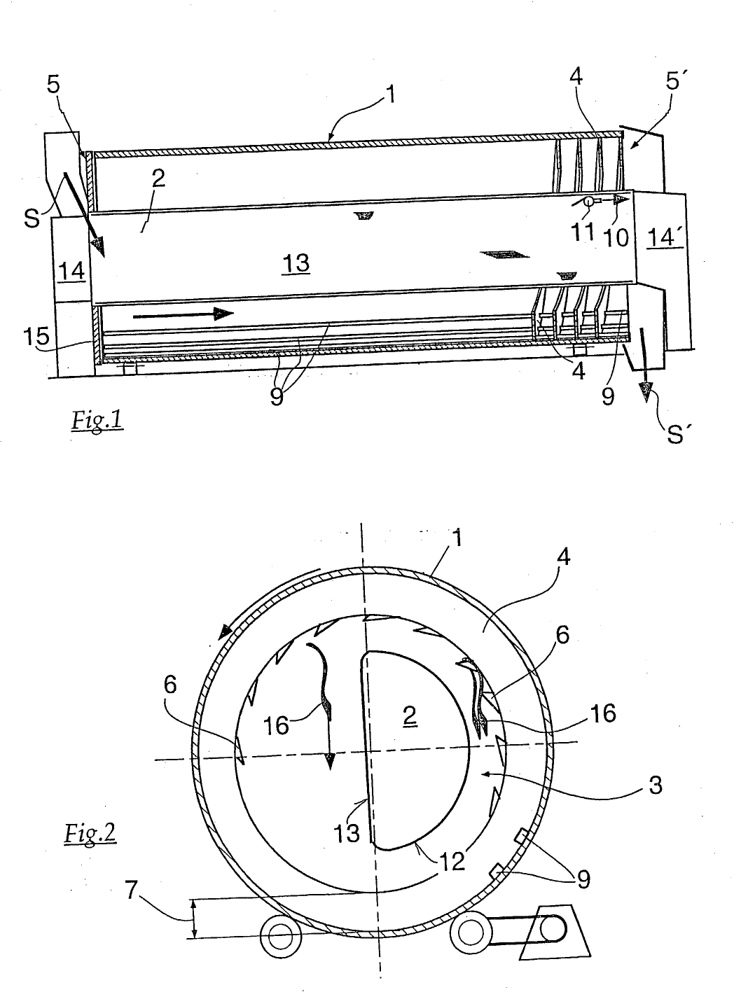

A possible embodiment of a drum for carrying out the process according to the invention is shown in FIG. 1, in which the drum 1 is shown in sectional side view. It is charged from the left with the contaminated recovered paper S, that is fed in on the first face 5, to which end a feed opening is located in the stationary face wall 15 sealed against the drum. The recovered paper is then moved inside the drum from the first to the second face 5′. The lifting movement on the part of the drum moving upward is provided by transporting bars 9 attached to the drum inside wall, only a few of which transporting bars are drawn here. A displacement body 2 is arranged inside the drum and along its entire length, which displacement body is held on both sides from the outside by supports 14 and 14′. On a part of its circumference the displacement body 2 has a curved outside wall 12 and on the other part an essentially flat, here approximately perpendicular outside wall 13. These conditions can be seen from FIG. 2. A processing channel 3 is thus formed between the curved outside wall 12 and the inside wall of the drum in which channel a very intensive mechanical processing of the recovered paper takes place. The size of the shear forces thereby occurring is sufficient on the one hand to carry out an intensive slushing of the wet paper webs, but on the other hand does not yet lead to an undesirable crushing of the contaminants. The treatment of the recovered paper is combined with a falling movement, through which the paper conveyed with the aid of the drum on the upper part of the displacement body 2 falls along the straight outside wall 13. The combination of these two processing principles is advantageous, on the other hand, however, the dropping can also be dispensed with, at least for sections.

The essential innovation of the process can be seen in FIG. 1. A coil 4, which is here attached to the inside contour of the drum 1, is located directly in front of the second face 5′. This coil transports the pulp S′ that has arrived there out of the drum again. It can then be sorted, e.g., in a subsequent wire device (not shown) such that a dirt fraction and a fibrous stock fraction are formed. The coil 4 can also be seen in FIG. 2. The coil can also be provided with a number of projections 6 that advantageously have a hook-shape. It is thus very easy to attach the impurities 16 (merely indicated) with a tendency to spin in the parts of the drum moving upwards due to the rotary movement. When these impurities have passed the upper part of the displacement body 2, they can be detached from the hooks again and then fall back onto the bottom of the drum or out of it. Instead of the projections 6 shown here, naturally suitable indentations in the coil 4 can also achieve a similar effect and would have the advantage of a possibly lower risk of wear or damage. A simple tooth profile would also be conceivable.

The height 7 with which the coil 4 projects over the inside wall of the drum is an important parameter in carrying out the process. It must be large enough so that a backwash can form upstream, in order to give the stock an adequate dwell time for slushing. It is possibly useful to vary the height 7 of the coil in the axial direction, e.g., to increase it the upstream part, in order to be able to form a larger backwash. Another possibility is not to keep the angle of pitch of the coil constant, in order to adjust the axial conveyance to the requirements in certain areas from an axial point of view. The coil can also be supported separately and driven at another-preferably slower-rotational speed than that of the drum, in order to thus influence the axial conveyance speed. However, that is associated with greater additional expense in terms of equipment.

The discharge of the contaminants can additionally be improved by one or more pressure water jets 10 directed radially outwards, to which end a jet tube 1 is drawn here. Since it is stationary, it would be easy to attach it to the displacement body 2. Dilution with water is relatively harmless here, since as a rule the subsequent sorting is conducted at lower consistency anyway.

The transporting bars 9 extend according to FIG. 1 essentially over the entire axial length L of the drum. However, shorter or interrupted embodiments are also conceivable.

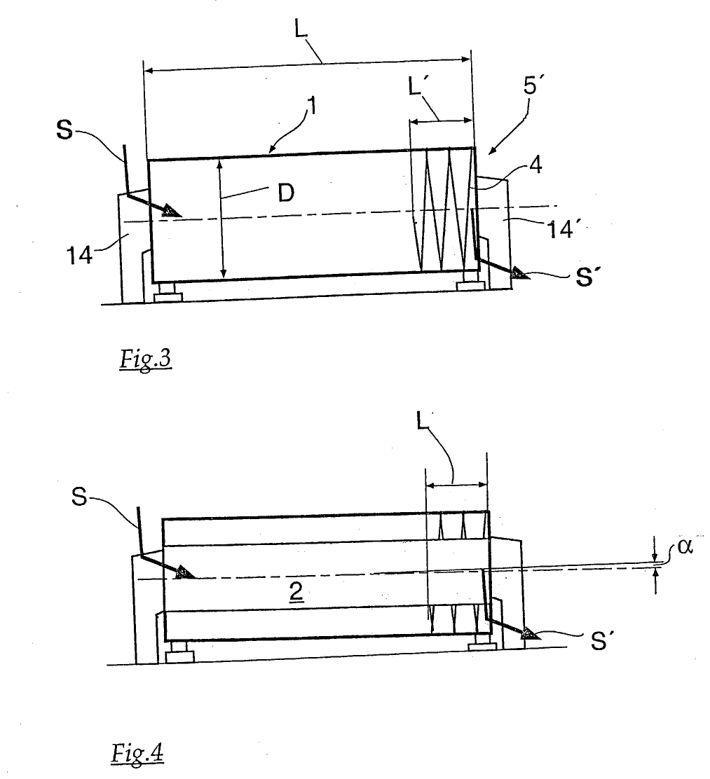

Drums suitable for the process are relatively large as a rule. This makes them robust, reliable in operation and suitable for large production amounts. Their length L (cf. FIG. 3) is advantageously at least 6 m, preferably 10 to 15 m, and their interior diameter D at least 2 m, preferably 3 to 4 m. The axial length L′ of the coil 4 can be advantageously at least 10% of the length L of the drum, preferably at least 2 m. The displacement body is not shown in FIG. 3 for reasons of improved clarity.

As FIG. 4 shows, the drum 1 can also be lowered by several degrees at an angle of tilt α to the outlet, which promotes the axial conveyance in the drum and the discharge from the drum.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A process for slushing contaminated recovered paper in a slushing device that includes a rotatable drum having a first and second face on opposite axial ends and at least one displacement body having an outside wall curved at least in sections located inside the drum and held from outside of the drum, such that a processing channel is formed between at least the curved section of the outside wall of the displacement body and at least a part of an inside wall of the drum in order to mechanically process the recovered paper, said process comprising:
feeding recovered paper contaminated with impurities into the drum on the first face;
moving the recovered paper and impurities within the drum from the first to the second face;
transporting the recovered paper and impurities out of the drum at the second face together with the aid of a rotating coil.

2. The process in accordance with claim 1, further comprising rotating the inside wall of the drum at at least 20 cm/sec in the circumferential direction.

3. The process in accordance with claim 1, wherein backwash for the recovered paper to be treated in the drum is formed with the coil.

4. The process in accordance with claim 1, wherein the impurities include long impurities and an inside of the coil includes at least one of projections and edges, and the process further comprises transporting at least a part of the long impurities over the displacement body via the at least one of projections and edges, and subsequently releasing the at least a part of the long impurities from the at least one of the projections and edges.

5. The process in accordance with claim 1, further comprising rotating the drum and the coil at a same rotational speed.

6. The process in accordance with claim 1, further comprising rotating the drum and the coil at different rotational speeds.

7. The process in accordance with claim 6, wherein the coil is moved at a lower rotational speed than the drum.

8. The process in accordance with claim 1, wherein the coil is arranged with a height of at least 30 cm radially inwardly from the inside wall of the drum.

9. The process in accordance with claim 1, wherein the drum is oriented horizontally.

10. The process in accordance with claim 1, wherein the drum is oriented such that, during operation, a longitudinal axis of the drum is oriented at an angle of tilt to a horizontal reference of between 0.5 and 10°.

11. The process in accordance with claim 10, wherein the longitudinal axis is oriented at an angle of between about 0.5 to 2°.

12. The process in accordance with claim 1, wherein the drum includes transporting bars attached to the inside wall that are arranged to lift the pulp inside the drum.

13. The process in accordance with claim 1, further comprising detaching impurities adhering to the coil by spraying the coil with at least one pressure water jet directed axially.

14. The process in accordance with claim 13, wherein the at least one pressure water jet is formed by a jet tube attached to an upper part of the displacement body.

15. The process in accordance with claim 1, wherein the drum has an interior diameter of at least 2 m.

16. The process in accordance with claim 1, wherein the drum has a length of at least 6 m.

17. The process in accordance with claim 1, wherein the drum is not perforated.

18. The process in accordance with claim 1, wherein the drum is perforated on a maximum of 30% of its axial length directly in front of the second face.

19. The process in accordance with claim 1, wherein an axial length of the coil is at least 10% of an axial length of the drum.

20. The process in accordance with claim 1, wherein an axial length of the coil is at least 2 m.

21. The process in accordance with claim 1, wherein at least a part of the processing channel is located within an axial area of the coil.

22. An apparatus for slushing contaminated recovered paper comprising:
a rotatable drum having a first and second face on opposite axial ends, wherein said first face is structured and arranged to receive recovered paper contaminated with impurities;
at least one displacement body having an outside wall curved at least in sections, said at least one displacement body being located inside said drum and arranged to form a processing channel between at least said curved section of said outside wall of the displacement body and at least a part of an inside wall of the drum in order to mechanically process the recovered paper;
said at least one displacement body being held within said drum from outside of said drum; and
a rotatable coil positioned at the second face of said drum and arranged to transport the recovered paper and impurities out of said drum at the second face.

23. The apparatus in accordance with claim 22, wherein said inside wall of said drum is rotatable in the circumferential direction at at least 20 cm/sec.

24. The apparatus in accordance with claim 22, wherein said coil is structured and arranged to form backwash for the recovered paper to be treated in the drum.

25. The apparatus in accordance with claim 22, wherein an inside of the coil includes at least one of projections and edges structured and arranged to transport at least a part of long impurities over said displacement body via said at least one of projections and edges, and subsequently releasing the at least a part of the long, impurities from said at least one of said projections and edges.

26. The apparatus in accordance with claim 22, wherein said drum and said coil are rotatable at a same rotational speed.

27. The apparatus in accordance with claim 22, wherein said drum and said coil are rotatable at different rotational speeds.

28. The apparatus in accordance with claim 27, wherein said coil is rotated at a lower rotational speed than said drum.

29. The apparatus in accordance with claim 22, wherein said coil is structured with a height of at least 30 cm radially inwardly from said inside wall of said drum.

30. The apparatus in accordance with claim 22, wherein said drum is oriented horizontally.

31. The apparatus in accordance with claim 22, wherein said drum is oriented such that, during operation, a longitudinal axis of said drum is oriented at an angle of tilt to a horizontal reference of between 0.5 and 10°.

32. The apparatus in accordance with claim 31, wherein the longitudinal axis is oriented at an angle of between about 0.5 to 2°.

33. The apparatus in accordance with claim 22, wherein said drum comprises transporting bars attached to said inside wall that are structured and arranged to lift the recovered paper inside said drum.

34. The apparatus in accordance with claim 22, further comprising at least one pressure water jet axially directed to detach impurities adhering to said coil.

35. The apparatus in accordance with claim 34, wherein the at least one pressure water jet comprises a jet tube attached to an upper part of said displacement body.

36. The apparatus in accordance with claim 22, wherein said drum has an interior diameter of at least 2 m.

37. The apparatus in accordance with claim 22, wherein said drum has a length of at least 6 m.

38. The apparatus in accordance with claim 22, wherein said drum is not perforated.

39. The apparatus in accordance with claim 22, wherein said drum is perforated on a maximum of 30% of its axial length directly in front of said second face.

40. The apparatus in accordance with claim 22, wherein an axial length of said coil is at least 10% of an axial length of said drum.

41. The apparatus in accordance with claim 22, wherein an axial length of said coil is at least 2 m.

42. The apparatus in accordance with claim 22, wherein at least a part of said processing channel is located within an axial area of said coil.
